(19) United States
(12) Patent Application Publication
(10) Pub. No.: US 2026/0240151 A1
(43) Pub. Date: Aug. 20, 2026

(54) METHOD FOR IMPARTING ANTIMICROBIAL PROPERTIES TO A SYNTHETIC SUBSTRATE

(71) Applicant: BIOCOMPATIBILITY INNOVATION S.R.L., Este (Padova) (IT)

(72) Inventors: Filippo NASO, Este (Padova) (IT); Alessandro GANDAGLIA, Este (Padova) (IT); Ugo STEFANELLI, Este (Padova) (IT); Giulio STURARO, Este (Padova) (IT); Laura RUSSO, Este (Padova) (IT); Francesco NICOTRA, Este (Padova) (IT)

(21) Appl. No.: 19/164,721

(22) PCT Filed: Mar. 14, 2023
(86) PCT No.: PCT/IB2023/052468

§ 371 Date: Sep. 12, 2025

(51) Int. Cl. A01N 37/10; A01N 25/34; A01N 31/02; A01N 31/08; A01P 1/00

(52) U.S. Cl. CPC A01N 37/10; A01N 25/34; A01N 31/02; A01N 31/08; A01P 1/00

(57) ABSTRACT

A method for imparting antimicrobial properties to a synthetic substrate involves contacting the synthetic substrate with a treatment solution based on caffeic acid. The method further involves a pre-treatment of the synthetic substrate where the synthetic substrate is incubated in a pre-treatment solution of a C1-C4 alcohol.

The present invention finds application in the biomedical field and particularly relates to the treatment of synthetic substrates to provide antimicrobial properties.

### BACKGROUND OF THE INVENTION

As medicine and medical practice have evolved, so has the production of medical devices. The most widely used material to date is plastic, thanks to its peculiar characteristics and desirable attributes that have encouraged its increasing use over time. Among the many advantages of using plastics are undoubtedly its low weight compared to all other materials commonly used in medicine, the fact that it can be easily machined to effectively create even very small and complex components, and above all its flexibility. Moreover, is essential to also remember its resistance to chemicals, lipids, sterilization methods, disinfectants, and, finally, its biocompatibility. Today, different types of plastic materials are used in the construction of medical devices, from polyethylene to polyamide via nylon, depending on their intrinsic characteristics and the intended use of the device, which may be a suture thread, a catheter for deep venous access or use in urology or even a filter for embolic protection or hemodialysis. As the use of plastics in clinical practice progressed, their properties were naturally refined by researching mixtures of chemical agents, or directly new compounds, capable of responding more effectively to what were the problems that gradually arose from their daily use, until more recent times when real coatings with which to functionalize these materials began to be studied. These coatings can incorporate metals, like silver or copper, or antimicrobial agents like antibiotics or antifungals to further improve biocompatibility characteristics. However, despite numerous efforts, it has not yet been possible to obtain a plastic material, coated or uncoated, that fully embodies the desired characteristics. The most representative categories of plastic medical devices will be described below with particular attention to their limitations and the approaches currently available on the market to overcome them.

### CATHETERS

Catheters are made of different materials including polytetrafluoroethylene, polyurethane, polyethylene, and silicones. However, polyurethane remains the best choice which guarantees a high level of biocompatibility and the optimization between the external diameter and the wall thickness ensuring the optimization of the flow concerning the invasiveness of the device.

### VASCULAR CATHETERS

The three most common causes of vascular catheter dysfunction and failure are biofilm formation which leads to the development of a fibrin sheath, infection, and thrombus formation. Biofilm formation is an important factor in both early and late catheter failure and in catheter failure associated with infection. A biofilm is a complex structure formed by bacteria that have attached to an artificial surface. Bacterial attachment to the catheter surface and biofilm formation begins soon after catheter placement: electron microscopy showed bacterial attachment to the surfaces of indwelling vascular catheters as early as 24 hours after insertion. The bacteria proliferate and secrete a polysaccharide matrix which provides a medium for the attachment of additional organisms. Catheters become infected by two primary routes, depending on the length of time following the catheter placement procedure. Within the first 30 days after placement, catheters become infected by external routes mainly from the patient's skin microflora and the hands of the medical personnel. After the first 30 days, catheters become infected by internal routes, including contamination of the catheter hub which leads to hematogenous spread and bacteremia. The typical organisms involved in these infections include coagulase-negative staphylococci, Staphylococcus aureus, Pseudomonas, enterococci, and Candida. A clinical infection of the biofilm is typically resistant to antimicrobial treatment because of the failure of the antibiotics to penetrate all layers of the biofilm, and the slow-growing nature of the organisms involved, making the antibiotics ineffective. A biofilm evolves over weeks to months into a more complex structure: a fibrin sheath. A fibrin sheath can surround the catheter surface beginning at the venipuncture site and extending progressively down the length of the catheter until it eventually covers the catheter tip, thereby occluding the catheter lumen. The rate of catheter malfunction due to fibrin sheath formation has been reported to be as high as 50%. Finally, catheter failure resulting from thrombosis is a common problem in hemodialysis patients. Hemodialysis patients have unique blood physiology that makes them more susceptible to thrombosis formation. These factors include both platelet and plasma abnormalities.

### URINARY CATHETERS

Urinary tract infection (UTI) is one of the most common healthcare-associated infections reported to the CDC's National Healthcare Safety Network, with >560,000 cases occurring and over 13,000 attributable deaths (mortality rate of 2.3%) each year. UTI is also the leading cause of secondary nosocomial bloodstream infections with about 17% of hospital-acquired bacteremia from a urinary source, attributed up to a 10% mortality. Among UTIs acquired in hospitals, 75% of cases are associated with urinary catheters, referred to as catheter-associated urinary tract infections (CAUTI). In short-term catheterization (<3 days), most episodes of catheter-associated bacteriuria are asymptomatic with a single organism isolated, and <5% of catheter-associated bacteriuric patients are identified with bacteremia. However, in long-term catheterization (>28 days), almost all patients become bacteriuria. Two phenomena are observed during catheterization, the incidence of new episodes of bacteriuria by a wide variety of uropathogenic Gram-negative and Gram-positive bacterial species and the presence of persistent strains in the catheterized urinary tract. As the prolonged use of urinary catheters leads to a higher risk of acquiring UTIs, it is recommended to minimize catheter use during hospitalization. Besides, it is well-recognized that the use of urinary catheters favors microorganism adhesion and colonization, leading to infections, which are always associated with the occurrence of microbial biofilms. Biofilms are communities of surface-adherent micro-organisms, embedded in a self-generated extracellular matrix. Bacteria sequestered within the biofilm are key players in the pathogenesis of CAUTI because they are protected from host immune responses and antimicrobial agents. Within the biofilm, bacteria can transfer genes encoding for antimicrobial resistance and cell-to-cell communication can occur by a process called quorum-sensing.

Urinary system infections progressing with biofilm formation are 1000-fold more resistant to antibiotics compared with their planktonic equivalents, resulting in very challenging treatment. Furthermore, it is known that urease-producing agents, such as Proteus mirabilis, lead to the collapse of elements such as calcium, magnesium, and phosphate from the urine in short-term catheterizations. Obstruction occurs when encrustation develops to the point where the lumen is occluded. In patients with long-term catheterization, 48% developed catheter blockage and 37% developed bypassing (where urine passes continually around the outside of the catheter). These complications can be painful and result in incontinence of urine (this is distressing for the patient). Encrustation is a result of the ionic components in the urine crystallizing out onto the surface of the biomaterial and becoming incorporated into a bacterial biofilm layer. The bacterium most commonly detected in association with encrustation is Proteus mirabilis. Proteus produces an enzyme called urease, which cleaves urea to form ammonia and carbon dioxide. The carbon dioxide dissolves to form carbonic acid. However, as more ammonia is formed than carbonic acid this process results in a net decrease in H+ ion concentration, rendering the urine more alkaline. This change in pH has a profound effect on the solubility of struvite and calcium phosphate.

### EMBOLIC PROTECTION FILTERS

Manipulation of atherosclerotic lesions with wires, catheters, balloons, stents, and other intravascular devices during invasive procedures releases atherosclerotic plaque, resulting in distal embolization. This plaque debris leads to no or slow flow because of a multitude of factors, including mechanical obstruction of macrovascular and microvascular channels, local platelet adhesion, platelet activation, and thrombosis attributable to the release of tissue factors and microvascular spasm by release of thromboxane.

Embolic protection devices prevent or reduce plaque debris from reaching the distal bed and thereby have the potential to reduce adverse clinical events. The Embrella Deflector Device (Edwards Lifesciences) is an umbrella-like device with 2 heparin-coated polyurethane membranes mounted on an oval-shaped nitinol frame; the Sentinel (Claret Medical) device consists of 2 polyurethane filters placed in a flexible nitinol radiopaque frame attached to a 100-cm long delivery catheter; The TriGuard embolic protection device (Keystone Heart) features a nitinol mesh coated with chemical and physical substances (Applause TM Heparin Coating SurModics, Inc., Eden Prairie, MN, USA), thereby reducing the possibility of thrombus formation; the Embol-X EPD (Edwards Life Sciences) consists of a heparin-coated polyester mesh in a flexible nitinol frame. Generally, the problems of these filters are due not only to platelet activation and the consequent formation of thrombi but also to the potential clogging due to agglomerates of serum proteins which can alter their porosity.

### Mesh For Abdominal Wall Repair

Until 1958, the treatment for abdominal wall hernias are suture-based and the major problem faced by the then surgeons was the increased recurrence of the hernia. To overcome this, the concept of using a mesh was introduced by Usher. Synthetic meshes can be either permanent or absorbable. Permanent materials are generally composed of polypropylene, polyester, or expanded polytetrafluoroethylene (ePTFE). Each of these materials has benefits and limitations. They are often combined or additional materials to create “composite” meshes designed to take advantage of their strengths while combating their deficiencies. A wide variety of these composite meshes have been approved for clinical use. Permanent synthetic meshes are susceptible to infection, limiting their use in contaminated fields. A recent meta-analysis showed that the overall infection rate was 5%. Mesh removal was performed in 70% overall, and 100% of the ePTFE grafts.

### Polypropylene

Polypropylene has been extensively used in a wide variety of surgical procedures and is relatively inexpensive. Experimental studies have shown that polypropylene mesh is well incorporated into the anterior abdominal wall within 2 weeks of implantation. However, the inflammatory reaction may predispose to adhesion formation and result in the contraction of the mesh and surrounding tissues.

While the inflammatory response generated by polypropylene contributes to limiting its durability, it also increases adhesion formation when the mesh is used adjacent to the bowel. As a result, polypropylene is rarely used alone in the peritoneal cavity. Polypropylene may be combined with either a temporary or permanent material to reduce adhesion formation or isolate it from contact with the bowel (i.e. poliglecaprone, carboxy-methylcellulose, and omega-3 fatty acid). The inflammatory response to polypropylene also causes the material to contract by 30 to 50%. In addition to causing separation from the native tissue, the contraction can lead to the rolling of composite meshes, exposing the polypropylene component to the bowel surface.

Polyester Polyester is a carbon-based polymer frequently used in fabrics. Early studies raised concerns about higher infection, small bowel obstruction, recurrence, and fistula rates compared with other synthetic materials. Polyester meshes continue to be clinically available, with the caveat that they should be separated from the surface of the bowel. Polyester may offer some advantages over polypropylene. In an animal model of ventral hernia repair, a polyester mesh coated with a collagen hydrogel matrix (Parietex) showed superior incorporation into tissue than a composite mesh of polypropylene and sodium hyaluronate/carboxymethylcellulose (Sepramesh, Bard, Davol, Inc., Warwick, RI).

### Expanded Polytetrafluoroethylene (ePTFE)

ePTFE is a microporous woven mesh that was originally used in vascular grafts. The material used in abdominal cases generally has two sides: one side is smooth with small pores, and the other has larger pores with ridges and groves. The material is designed to place the smooth side toward the bowel to minimize adhesions, and the rough side toward the fascia to allow for tissue ingrowth. However, experimental studies have shown limited ingrowth of fibers and minimal inflammatory changes surrounding ePTFE grafts. This may be a result of small pore size, hydrophobicity, or the electronegative charge of the mesh. In an animal model of ventral hernias, grafts constructed with ePTFE were compared with those of polypropylene. While the ePTFE grafts showed less evidence of adhesions, there was no ingrowth of fibro-collagenous tissue into the ePTFE graft. The polypropylene mesh was completely incorporated. In addition, hernia recurrence was 60% in the ePTFE group, compared with 0% in the polypropylene group. All of the recurrent hernias were at the junction of the mesh and the native tissue, suggesting that the lack of ingrowth into the ePTFE resulted in the insufficient anchorage of the mesh to the fascia.

To overcome the limitations of the various devices illustrated, novel coatings, materials, and designs have been deeply investigated. Engineering approaches fall into three main categories: (i) anti-microbial; (ii) anti-fouling and (iii) anti-thrombotic. Anti-microbial strategies include passive antimicrobial release (typically by impregnation into the plastic surface) and non-release contact killing (by antimicrobial compounds covalently anchored to the plastic material or by incorporation in a hydrogel coating). Antifouling materials or designs prevent bacterial adhesion using non-antimicrobial approaches, such as mechanical methods or unfavorable surface topography or chemistry. Finally, heparinized coatings have been widely applied due to the ability of heparin to bind and induce an allosteric conformation change in antithrombin, thereby, dramatically accelerating its ability to inhibit FXa, thrombin, and other proteases that contribute to thrombus formation.

i) Antimicrobial strategies
Silver coating

Silver is one of the most popular antimicrobials for medical device coating, and one of the few antimicrobials approved by the FDA for urinary catheter application. The silver coatings can be applied on both the internal and external surfaces and slowly release ionic silver particles during the first 5 days and provide consistent elution over time. The silver-coated synthetic materials reduce pathogen colonization by releasing silver ions into the surrounding environment which target bacteria by three mechanisms: (1) impaired membrane function by loss of membrane potential, (2) protein dysfunction by the destruction of Fe-S cluster, and (3) oxidative stress by antioxidant depletion.

### Antibiotic Voatings

Antibiotics selectively inhibit the biological activities of microorganisms at low concentrations, which is pivotal for the prevention and control of infectious diseases. Antibiotic coatings are perhaps the most direct method to prevent bacterial infection, designed to inhibit or delay the onset of biofilm formation by a controlled release of high-local concentration of antibiotics at the potential site of colonization. Compared to silver coatings, antibiotic coatings have a high activity to target the pathogen. To date, many antibiotics have been impregnated into plastic medical devices, including nitrofurazone, gentamicin, norfloxacin, sparfloxacin, vancomycin, and rifampin.

Noteworthy, nitrofurazone may lead to mammary and ovarian tumors in animal subjects and hence has been listed under prohibited drugs for food animals under Group I by FDA. This side effect of nitrofural has led to the slowdown of research in this field. Catheters coated with antimicrobial substances are beneficial in preventing catheter-associated urinary system infections, however, cost, patient convenience, and complications associated with these catheters should also be considered. The greatest concern for all antimicrobial-treated medical devices is the development of resistance against active/coated substances. Thus, their use may be losing ground due to limited efficacy and the potential development of resistance.

Bactericidal enzyme coatings

Bactericidal enzymes inhibit bacteria through the production of antimicrobial substances (i.e., oxidative enzymes). Specifically, the hydrogen peroxide (H₂O₂) produced by peroxidases is used to attack bacterial cells or oxidize halides to more potent antimicrobials. Recently, bactericidal enzymes have been used as highly active antibacterial materials for experimental catheter coating. The bactericidal enzymes have several advantages over other conventional antimicrobials as catheter coatings. (1) they are more specific toward selected pathogens without disturbing the other benign microorganisms in the host, (2) it is very difficult for the pathogens to develop resistance to bactericidal enzymes, (3) bactericidal enzymes are considered as natural, nonreactive, and nontoxic to the host. However, the production and purification of bactericidal enzymes are much more expensive compared to conventional antimicrobials, such as silver and antibiotics. Moreover, bactericidal enzymes are prone to denaturation in extreme conditions during device sterilization, storage, and transport.

Antimicrobial peptide (AMP) coatings

AMPs or so-called host-defense peptides are broad-spectrum antimicrobials that are effective to both Gram-negative and Gram-positive strains, viruses, and fungi. AMPs target the pathogens through multiple pathways: (1) alternation of cytoplasmic membrane; (2) membrane permeabilization; (3) activation of autolysin; (4) inhibition of DNA, RNA, and protein synthesis; (5) inhibition of certain enzymes; (6) enhancement of immunomodulation. These AMP-coated catheters showed excellent antimicrobial and antibiofilm activities against pathogens, and did not exhibit toxicity toward mammalian cells.

ii) Antifouling strategies

Antifouling materials or designs are inherently resistant to bacterial attachment and subsequent biofilm formation due to their structure alone, without the need for antimicrobial additives. Mechanisms of antifouling include hydration forces, steric repulsion, electrostatic repulsion, and low surface energy. The field of antifouling polymers is fast-growing and shows promise as an exciting new approach to combat bacterial infection with no potential for exacerbating antibiotic resistance. PEG coating PEG is a hydration layer with a large energetic barrier and steric repulsion to nonspecific protein adsorption. PEG coating on the substrates is designed to prevent bacterial adhesion. This coating demonstrated excellent antibacterial and antifouling activities against both Gram-positive (S. aureus) and Gram-negative (E. coli) bacteria. While PEG-based coating has been historically regarded as the gold standard of protein-resistant surfaces, drawbacks still exist in the use of PEG. Recent studies indicated PEG provokes an immune response in ~25% of the population. In addition, the long-term stability of the PEG coating is compromised by the oxidative degradation of the polyether backbone.

Hydrogel coatings

The formation of a hydrogel layer is another strategy to achieve protein resistance. Hydrogels are lightly cross-linked polymer networks that can swell and retain large amounts of water. Similar to PEG grafted surface, hydrogel forms a hydration layer, which increases surface hydrophilicity and establishes a barrier to inhibit nonspecific protein adsorption. Very often the hydrogel coating approach is coupled with the silver-based treatment. However, the hydrogel layer was reported to increase aggregation of the planktonic cells and newly nucleated crystals, leading to even faster catheter blockage than in the case of uncoated silicone.

Polyzwitterion coatings

Polyzwitterions bear both cationic and anionic groups along the polymer backbone, which are overall in charge neutrality. Polyzwitterions are highly hydrophilic to form a hydration layer on the surface. Polyzwitterions also repel non-specific protein absorption through electrostatic and steric repulsion. It has been demonstrated that the polyzwitterionic surface is a potent alternative to the conventional antifouling PEGylated surface. The three most common zwitterionic polymers are phosphorylcholine (PC), sulfobetaine, and carboxy betaine. Unlike the permanently charged polymers, the zwitterionic polymers can switch between anionic and cationic forms by a controlled hydrolysis process, where the release of dead bacteria and antifouling occur on the same substrate. However, the long-term stability of the zwitterionic surface is still a concern. The surface hydration layer of polyzwitterion may break down and lose its antibacterial activity, leading to the adhesion of bacteria on the surface of the modified coating.

Nitric oxide release coating

Nitric oxide (NO) is a chemically unstable, lipophilic gas, and one of the smallest endogenously produced molecules against infection. NO exhibited both local bactericidal/biofilm dispersal effects by amino and sulfhydryl nitrosation, lipid peroxidation, tyrosine nitration, DNA breakdown, and stimulation of motility and regulation of dispersal. Once generated by the activated immune cells, NO could diffuse through bacterial cellular membranes to destroy the microorganism by exerting nitrosative and oxidative stress. The common NO donors are S-nitrosothiols, such as S-Nitroso-N-acetyl-DL-penicillamine (SNAP) and S-Nitrosoglutathione (GSNO), which can be blended into polymer materials for the slow release of NO. NO-releasing polymeric coatings have been widely applied to prevent biofilm-related infections on implant biomedical devices. But, very few studies have been conducted with NO or NO donor-impregnated urinary catheters. The long-term storage stability, NO donor diffusion in the physiological environment, and toxicity of the materials are still major concerns that required further investigation.

iii) Anti-thrombotic coatings

There are two antithrombotic coatings available on tunneled, hemodialysis catheters-the Carmeda BioActive Surface (CBAS) on Spire Biomedical catheter products and the Trillium Biosurface developed by BioInteractions Ltd. (Reading, Berks, UK) available on Tyco-Kendall products. Both surfaces use heparin bonded to the catheter as an anticoagulant. Heparin is not only a strong anticoagulant but has been shown in many studies to both reduce thrombin-activated factors and the proliferation of smooth muscle cells. However, the early clinical benefit noted for blood-contacting devices with a heparinized coating is typically not maintained, presumably due to the inability to sustain heparin surface activity as a consequence of enzymatic or chemical degradation with reduced availability of high-affinity antithrombin binding sites. In particular, heparin and heparan sulfates are depolymerized and degraded by heparanase, an endo-ß-D-glucuronidase, produced by a variety of cells and tissues, including fibroblasts, endothelial cells, platelets, activated immune cells, hepatocytes, and cancer cells. Plasma heparanase activity is significantly elevated among patients with atherosclerosis, renal insufficiency, and type 2 diabetes, as well as after surgery, which may further contribute to the early reduction in clinical benefit from heparin-bonded prostheses. Significantly, unfractionated and low molecular weight heparin are susceptible to cleavage by heparanase with a reduction in the local concentration of high-affinity antithrombin binding sites and neutralization of anticoagulant properties.

Polyphenols are widely found in many plant products, such as green tea, red wine, cocoa, and fruits. They are readily available and inexpensive and are generally recognized as safe by the U.S. Food and Drug Administration.

Yang L and colleagues [6] describe the procedure to obtain a coating on a quartz or silicon slide using tannic acid coordinated by metallic bonds with Fe³⁺. The Fe-TA film results effective in preventing platelet adhesion, however, the procedure is long and complex and involves a pre-treatment with a very aggressive boiling solution (98% H₂SO₄: 30% H₂O₂=3:1) and a subsequent passage in trimethylchlorosilane (4% dichloromethane) for 4 hours.

The approach above described uses complex procedures, and critical processing conditions and is specific only to certain types of plastic substrates.

The inventors of the present application have disclosed the use of polyphenols for the functionalization of tissues of animal origin for the manufacture of biological prostheses [1-6].

### SUMMARY OF THE INVENTION

The inventors of the present patent application have surprisingly found that synthetic substrates may be treated so as to impart them antimicrobial property so that these substrates may be used for the manufacturing of medical devices.

### BRIEF DESCRIPTION OF THE FIGURES

FIG. 1: Scanning electron microscopy evaluation of internal and external surface of original polyurethane samples (untreated) and after the treatment with two variants of the solution based on caffeic acid (CA-treated 1 and CA-treated 2).

FIG. 2: Scanning electron microscopy evaluation of original polyamide mesh samples (untreated) and after the treatment with two variants of the solution based on caffeic acid (CA-treated 1 and CA-treated 2). At the base of the figure, the result of the EDX assessment has been reported which compares the untreated sample with that subjected to variant CA-treated 1. It can be seen how the amount of C or O atoms increases significantly in the treated sample confirming the stable interaction with the mixture of polyphenolic (rich in C and O).

FIG. 3: Scanning electron microscopy evaluation of original silicone samples (untreated) and after the treatment with two variants of the solution based on caffeic acid (CA-treated 1 and CA-treated 2).

FIG. 4: proton nuclear magnetic resonance analysis of polyurethane samples after the treatment with two variants of the caffeic acid-based solution (P1 and P2).

FIG. 5: carbon 13 nuclear magnetic resonance analysis of polyurethane samples untreated (NT) and after the treatment with a caffeic acid-based solution (P2).

FIG. 6: carbon 13 nuclear magnetic resonance analysis of polyamide samples untreated (CTRL) and after the treatment with two variants of the caffeic acid-based solution (P1 and P2).

FIG. 7: proton nuclear magnetic resonance analysis of silicone samples before (CTRL) and after the treatment with two variants of the caffeic acid-based solution (Sample 1 and Sample 2).

FIG. 8: carbon 13 nuclear magnetic resonance analysis of silicone samples before (CTRL) and after the treatment with a caffeic acid-based solution (Sample 2).

FIG. 9: percentage of reduction in proteins adhesion for different plastic support as assessed on bovine serum albumin and bovine thyroglobulin.

FIG. 10: percentage of reduction of the adhesiveness of different bacterial strains on different types of plastic supports.

FIG. 11: thrombin generation assay performed on polyurethane (PU), silicone (SI), polyamide (PA), and polyester (PE) samples before (NT) and after the treatment with a caffeic acid-based solution. The samples are compared with reference material constituted by Medical steel (MS, high propensity to thrombin generation) and low-density polyethylene (LDPE, low propensity to thrombin generation).

### OBJECT OF THE INVENTION

In a first object, the present invention discloses a method for imparting antimicrobial properties to a synthetic substrate.

In a particular embodiment, said synthetic substrate is selected from the group comprising: polyurethane, polyesters, polyamides, silicones, PEEK, Polytetrafluoroethylene and expanded Polytetrafluoroethylene.

In particular embodiment, the method of the invention can also provide to said synthetic substrate one or more properties selected from the group comprising: inhibition of the surface adhesiveness to serum proteins, resistance to tissue bacterial adhesion, thrombin generation inhibition.

In a second object, the present invention discloses a synthetic substrate obtained according to the method described and a medical device comprising such a substrate.

In a particular embodiment, said medical device is selected from the group comprising: catheters, such as vascular catheters, urinary catheters, embolic protection filters, mesh for abdominal wall repair.

### DETAILED DESCRIPTION OF THE INVENTION

According to the first object of the invention it is disclosed a method for imparting antimicrobial property to a synthetic substrate.

In particular, said synthetic substrate is represented by a plastic substrate.

In a preferred embodiment, said plastic substrate is represented by a material selected from the group comprising: polyurethane, polyesters, polyamides, polyethylene, silicones, PEEK, polyacrylates, acrylic hydrogels, Teflon, polysiloxane, fluorinated polymers.

In particular, polyesters include for instance: polyethylene terephthalate, nylon, Dacron, polyglycolic acid, polylactic acid, polycaprolactone.

In particular, polyamides include Kevlar.

In particular, polyethylene includes low-, high-and ultrahigh-molecular weight polyethylene.

In particular, polyacrylates include polymethyl methacrylate and polymethyl acrylate.

In particular, polysiloxane include Silastic.

In particular, fluorinated polymers include polytetrafluoroethylene and expanded polytetrafluoroethylene.

According to the present invention, the method disclosed may comprise a preliminary step of pre-treatment of said substrate.

In particular, said pre-treatment comprises the incubation of the substrate in a pre-treatment solution of alcohol.

More in particular, said alcohol has a concentration of about 10-100% (v/v) and preferably of 100% (v/v).

In an embodiment, the incubation of the pre-treatment is continued for a period of time of from 2 minutes to 24 hours.

In a preferred embodiment, the pre-treatment incubation is performed for about 10 minutes. According to a preferred embodiment of the invention, before said pre-treatment step, the pre-treatment solution is maintained at a temperature of about −25° C. to −15° C.

In a preferred embodiment, the pre-treatment solution is maintained at a temperature of about −20° C.

In a preferred embodiment, the pre-treatment solution is maintained at the disclosed temperature for a period of time from about 10 minutes to 5 hours.

For the purposes of the present invention, the method of the invention comprises a step of contacting said substrate with a treatment solution based on caffeic acid.

In particular, said treatment solution based on caffeic acid has a concentration of caffeic acid of between 0.1-10 mg/ml.

In a preferred embodiment, said treatment solution has a concentration of caffeic acid of about 2-4 mg/ml.

The treatment solution of the invention is prepared by dissolving caffeic acid in 70% (v/v) of the final volume in alcohol.

In particular, for the preparation of the treatment solution, the caffeic acid is dissolved in a C1-C4 alcohol.

In a preferred embodiment, the C1-C4 alcohol is selected in the group comprising: methanol, ethanol, isopropanol or butanol.

The pH of the treatment solution is then adjusted to a range between 2.5 and 9.0 and preferably of between pH 5.5 and pH 8.0.

According to an embodiment of the present invention, the treatment solution comprises a second component.

For the purposes of the present invention, said second component is selected from the group comprising polyphenols and their salts or ester, phenolic compounds and their salts and derivatives, antibiotics or antimicrobial agents, methylated phenols, fatty acids and their esters and metal-based solutions.

In particular, said polyphenols are selected from the group comprising: resveratrol, aloin, cyanarin, epigallocatechin, tannic acid, chlorogenic acid, hydroxytyrosol, rosmarinic acid, narigenin, gallic acid, hesperidin, quinic acid, eleonolic acid, pinoresinol, luteolin, apigenin, tangeritin, isorhamnetin, kaempferol, myricetin, eriodictyol, theaflavin, thearubigins, daidzein, genistein, glycitein, pterostilbene, delphinidin, malvidin, pelargonidin, peonidin, chicoric acid, ferulic acid, salicylic acid, baicalein, 5,7-dihydroxy-4-phenyl coumarin, rutin hydrate, 5,8-dihydroxy-1,4-naphthoquinone, 2,3-dichloro-5,8-dihydroxy-1,4-naphthoquinone, ethyl-3,4-dihydroxy-cinnamate, butyl gallate, 4-hydroxyl-4-biphenyl-carboxylic acid, oleuropein, garlic acid, magnolol, curcumin, ethyl-3,5-dihydroxy-benzoate.

In particular, said phenolic compounds are selected from the group comprising: vanillin, cinnamic acids, phenylalanine, coumarins, xanthones, catechins, flavononids, flavones, chalcones, flavanonols, flavanols, leucoanthocyanidin, anthocyanidin, hydroxycinnamic acids, phenylpropanoids.

Derivatives of such phenolic compounds, represented by salts and esters, are also included. In particular, said antibiotics or antimicrobial agents are selected from the group comprising: penicillins, aminoglycosides, carbapenems, glycopeptides, and lipoglycopeptides such as vancomycin, monobactams aztreonam, oxazolidinones such as linezolid and tedizolid, rifamycins, streptogramins such as quinupristin and dalfopristin, cephalosporins, tetracyclines, macrolides, fluoroquinolones, sulfonamides.

In particular, said methylated phenols are selected from the group comprising: α-tocopherol, β-tocopherol, γ-tocopherol, δ-tocopherol and tocotrienols.

In particular, said metal-based solution is selected from the group comprising: acetates, sulphates, phosphates, chlorides, nitrites, nitrates or carbonates.

Metal can be selected from the group comprising: iron, silver, gold, zinc, copper, barium, magnesium, and aluminum.

For instance, there can be used barium carbonate, iron (II) chloride, iron (III) chloride, iron (II) nitrate, iron (III) nitrate, aluminum chloride, calcium chloride, calcium carbonate, calcium nitrate, copper sulphate, copper nitrate.

For the purposes of the present invention, said second component has a concentration of about 0.1-20 mg/ml.

The treatment solution of the invention is prepared by admixing a solution of caffeic acid with a solution of the second component.

In particular, the solution of caffeic acid is preferably represented by an alcoholic solution of caffeic acid.

In a preferred embodiment, the solution of caffeic acid is prepared by dissolving caffeic acid in 70% (v/v) of the final volume in alcohol.

In particular, for the preparation of the treatment solution, the caffeic acid is dissolved in a C1-C4 alcohol.

In a preferred embodiment, the C1-C4 alcohol is selected in the group comprising: methanol, ethanol, isopropanol or butanol.

In a preferred embodiment, the solution of the second component is prepared by dissolving the second component in an aqueous buffer.

For the purposes of the present invention, a suitable buffer can be selected form the group comprising: PBS (phosphate buffer), bicarbonate buffer, Dulbecco's Phosphate Buffered Saline, TBE (tris/borate/EDTA buffer), TE (Tris/EDTA) buffer, Tris-buffered saline (TBS), SSC (sodium chloride/sodium citrate), and SSPE (sodium chloride/sodium phosphate/EDTA).

Finally, the two solutions are mixed and the pH is adjusted in a range between 2.5 and 9.0 and preferably of between pH 5.5 and pH 8.0.

For the purposes of the present invention, the method of the present invention comprises at least one treatment cycles, which comprises the steps wherein:
i) said synthetic substrate is incubated in said treatment solution and then
ii) said incubated synthetic substrate is washed.

In particular, said step i) of incubation is performed for a period of time of from about 5 to 25 minute and preferably of about 15 minutes.

In particular, said step ii) of washing is performed for a period of time of from about 2 to 120 minutes and preferably of about 20 minutes.

For the purposes of the present invention, the treatment step i) comprises at least one cycle performed at pH 5.5.

For the purposes of the present invention, the treatment step i) further comprises at least one cycle performed at pH 8.0 carried out after the treatment the washing at pH 5.5.

In an embodiment of the present invention, the treatment step i) comprises from 1 to 5 treatment cycles performed at pH 5.5.

Preferably, the treatment step i) comprises 3 treatment cycles performed at pH 5.5.

In an embodiment of the present invention, the treatment step i) further comprises from 1 to treatment cycles performed at pH 8.0, wherein each step at pH 8.0 is carried put after each step at pH 5.5.

Preferably, the treatment step i) comprises 3 treatment cycles performed at pH 8.0, wherein each step at pH 8.0 is carried put after each step at pH 5.5.

For the purposes of the present invention, the treatment step i) is performed in the dark.

As per step ii), the washing is performed with a washing solution represented by a buffer solution.

In particular, the buffer solution is selected from the group comprising: PBS (phosphate buffer), bicarbonate buffer, Dulbecco's Phosphate Buffered Saline, TBE (tris/borate/EDTA buffer), TE (Tris/EDTA) buffer, Tris-buffered saline (TBS), SSC (sodium chloride/sodium citrate), and SSPE (sodium chloride/sodium phosphate/EDTA)

For the purposes of the present invention, after the treatment step it is further performed a drying step.

In particular, said drying step is performed at a temperature of about 30-45° C.

In particular, said drying step is performed for a period of time of from about 1 minute to 5 hours and preferably of about 30 minutes.

According to the present invention, the method disclosed above provides antimicrobial properties to the treated synthetic substrate.

In particular, said antimicrobial properties are versus: Staphylococcus aureus, Pseudomonas aeruginosa, Escherichia coli, Proteus mirabilis, Enterococcus faecalis, Listeria monocytogenes, Salmonella enterica typhimurium, Streptococcus viridans, nontuberculous mycobacterium such as Mycobacterium chelonae, yeast such as Candida albicans and fungus such as Aspergillus brasiliensis.

In a preferred embodiment, said antimicrobial properties are versus: Staphylococcus aureus, Escherichia coli and Proteus mirabilis.

In addition, the method of the invention provides one or more of the following properties: inhibition of the surface adhesiveness to serum proteins, resistance to tissue bacterial adhesion, thrombin generation inhibition.

In particular, said properties of resistance to tissue bacterial adhesion are versus: Staphylococcus aureus, Escherichia coli, Proteus mirabilis, Pseudomonas aeruginosa, Enterococcus faecalis, Listeria monocytogenes, Salmonella enterica typhimurium, Streptococcus viridans, nontuberculous mycobacterium such as Mycobacterium chelonae, yeast such as Candida albicans and fungus such as Aspergillus brasiliensis.

In a preferred embodiment, said properties of resistance to tissue bacterial adhesion are versus: Staphylococcus aureus, Escherichia coli and Proteus mirabilis.

According to a second object of the invention, it is disclosed a synthetic substrate obtained according to the method of the invention.

In particular, the synthetic substrate is in a material selected from the group comprising: polyurethane, polyesters, polyamides, polyethylene, silicones, PEEK, polyacrylates, acrylic hydrogels, Teflon, polysiloxane, fluorinated polymers, as above disclosed.

Furthermore, it is disclosed a medical device comprising such a substrate.

For the purposes of the present invention, a medical device is selected in the group comprising: catheters, such as vascular catheters, urinary catheters, embolic protection filters, mesh for abdominal wall repair, syringes, kits intended for various types of use, laboratory tubes, blood bags, tools, gloves, trays, thermometers and sutures.

The present invention will be further disclosed by the following experimental section.

### Experimental Section

### Polyurethane (PU)

In particular polyurethane samples were incubated for 10 minutes in a 100% (v/v) isopropanol solution. Before use, the alcoholic solution has been placed at −20° C. for a time interval ranging from 10 minutes to 5 hours.

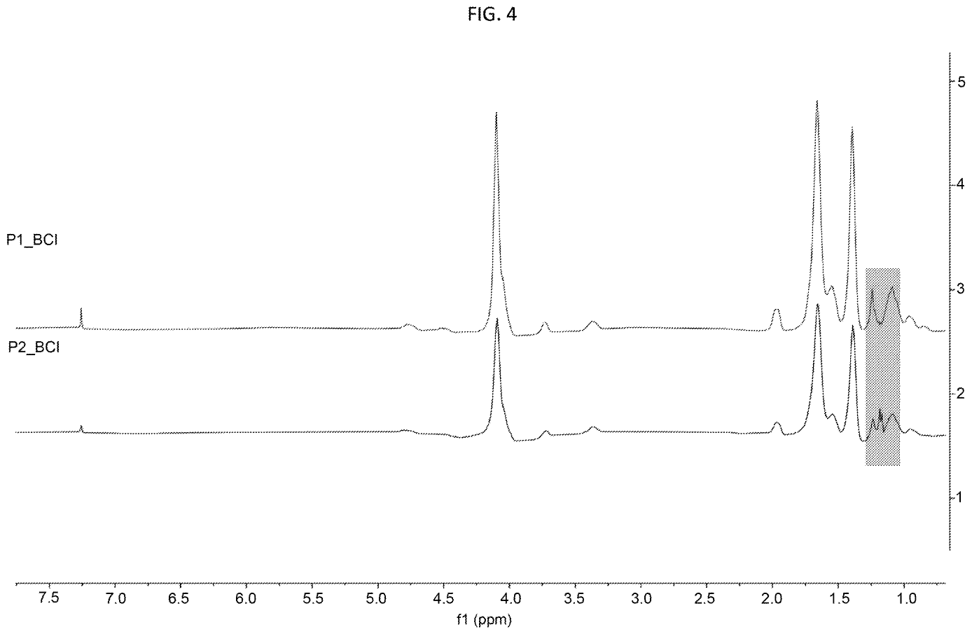

The samples were subsequently incubated in two different mixtures of caffeic acid-based polyphenols, specifically: variant 1 (P1 in FIG. 4) consisting of caffeic acid at a concentration of 2 mg/ml and tannic acid at a concentration of 4 mg/ml was chosen and variant 2 (P2 in FIG. 4) consisting of caffeic acid at a concentration of 2 mg/ml and rutin hydrate at a concentration of 1 mg/ml was chosen.

For both variants the caffeic acid was dissolved in 70% of the final volume in isopropanol.

The second polyphenol was dissolved in 30% of the final volume in PBS (phosphate buffer). Finally, the two solutions are mixed and the pH is adjusted in a range between pH 5.5 and pH 8.0.

The polyurethane samples are then incubated in these caffeic acid-based solutions for 3 cycles at pH 5.5 and a further 3 cycles at pH 8.0.

An incubation time in a caffeic acid-based polyphenolic solution of 15 minutes was used for each cycle, and each cycle was followed by a wash in TBE (Tris/borate/EDTA buffer) lasting 20 minutes.

After the treatment cycles, the samples were placed in a stove at 37° C. for a time of 30 minutes.

### Polyamide (PA)

Polyamide samples were incubated for 10 minutes in a 100% (v/v) ethanol solution. The incubation time can vary from 2 minutes to 24.

Before use, the alcoholic solution has been placed at −20° C. for a time interval ranging from 10 minutes to 5 hours.

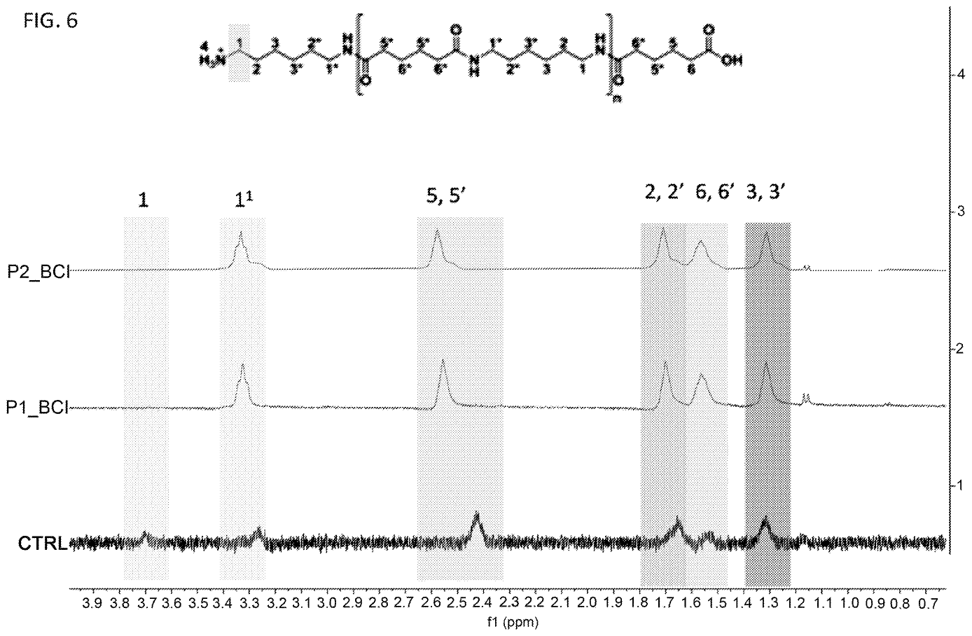

The samples were subsequently incubated in two different mixtures of caffeic acid-based polyphenols, specifically: variant 1 (P1 in FIG. 6) consisting of caffeic acid at a concentration of 4 mg/ml and tannic acid at a concentration of 8 mg/ml and variant 2 (P2 in FIG. 6) consisting of caffeic acid at a concentration between of 4 mg/ml and barium carbonate at a concentration of 1 mg/ml.

For both variants the caffeic acid was dissolved in 70% of the final volume in isopropanol.

The metal-based salt was dissolved in 30% of the final volume in PBS (phosphate buffer).

Finally, the two solutions are mixed, and the pH is adjusted in a range between 2.5 and 9.0 (in our case pH 5.5 and pH 8.0).

The polyamide samples are then incubated in these caffeic acid-based solutions for 3 cycles at pH 5.5 and a further 3 cycles at pH 8.0.

An incubation time in a caffeic acid-based polyphenolic solution of 15 minutes was used for each cycle, and each cycle was followed by a wash in TBE (Tris/borate/EDTA buffer) lasting 20 minutes.

after the treatment cycles, the samples were placed in a stove at 37° C. for a time interval of 30 minutes.

Silicon

Silicon samples were incubated for 10 minutes in a 100% (v/v) isopropanol solution. The incubation time can vary from 2 minutes to 24.

Before use, the alcoholic solution has been placed at −20° C. for a time interval ranging from 10 minutes to 5 hours.

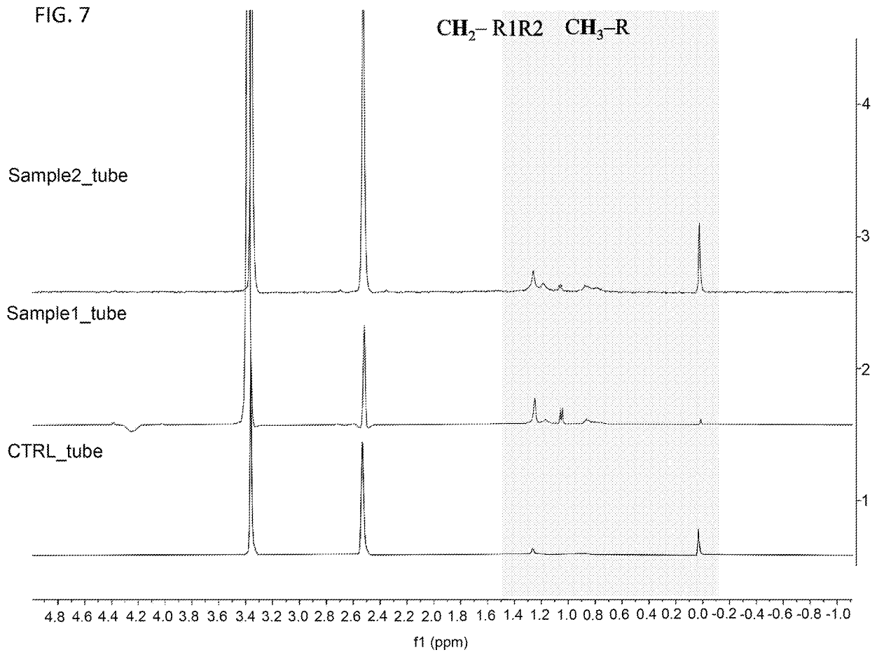

The samples were subsequently incubated in two different mixtures of caffeic acid-based polyphenols, specifically: variant 1 (Sample1 in FIG. 7) consisting of caffeic acid at a concentration of 2 mg/ml and tannic acid at a concentration of 4 mg/ml and variant 2 (Sample 2 in FIG. 7) consisting of caffeic acid at a concentration of 2 mg/ml and ganoderic acid at a concentration of 5 mg/ml was used).

For both variants the caffeic acid was dissolved in 70% of the final volume in isopropanol. The second polyphenol was dissolved in 30% of the final volume in PBS (phosphate buffer).

Finally, the two solutions are mixed, and the pH is adjusted in a range between pH 5.5 and pH 8.0.

The silicon samples are then incubated in these caffeic acid-based solutions for 3 cycles at pH 5.5 and a further 3 cycles at pH 8.0.

An incubation time in a caffeic acid-based polyphenolic solution of 15 minutes was used for each cycle, and each cycle was followed by a wash in TBE (Tris/borate/EDTA buffer) lasting 20 minutes.

After the treatment cycles, the samples were placed in a stove at 37° C. for a time interval of 30 minutes.

### Polyester (PE)

Polyester samples were incubated for 10 minutes in 100% (v/v) isopropanol solution. The incubation time can vary from 2 minutes to 24 hours.

The alcoholic solution has been placed at −20° C. for a time interval ranging from 10 minutes to 5 hours.

The samples were subsequently incubated in a mixture of caffeic acid-based polyphenols, consisting of caffeic acid at a of 4 mg/ml was chosen), tannic acid at a concentration of 8 mg/ml and a mixture of penicillin (150 μg/ml)/streptomycin (150 μg/mg)/neomycin(100 μg/ml).

The caffeic acid was dissolved in 70% of the final volume in isopropanol.

The polyphenol and antibiotics were dissolved in 30% of the final volume in PBS (phosphate buffer).

Finally, the two solutions are mixed and the pH is adjusted in a range between 5.5 and pH 8.0) The polyester samples are then incubated in these caffeic acid-based solutions for 3 cycles at pH 5.5 and a further 3 cycles at pH 8.0.

An incubation time in a caffeic acid-based polyphenolic solution of 15 minutes was used for each cycle, and each cycle was followed by a wash in TBE (Tris/borate/EDTA buffer) lasting 20 minutes.

After the treatment cycles, the samples were placed in a stove at 37° C. for a time interval of 30 minutes.

The treated and untreated plastic specimens were subjected to scanning electron microscopy (SEM) for surface evaluation, nuclear magnetic resonance (H- and C-NMR) for the characterization of the interaction with the support, tests for the evaluation of the ant-adhesiveness of several bacterial strains and serum proteins and thrombogenicity assessment.

### Results

### Scanning Electron Microscopy (SEM)

### Polyurethane Samples

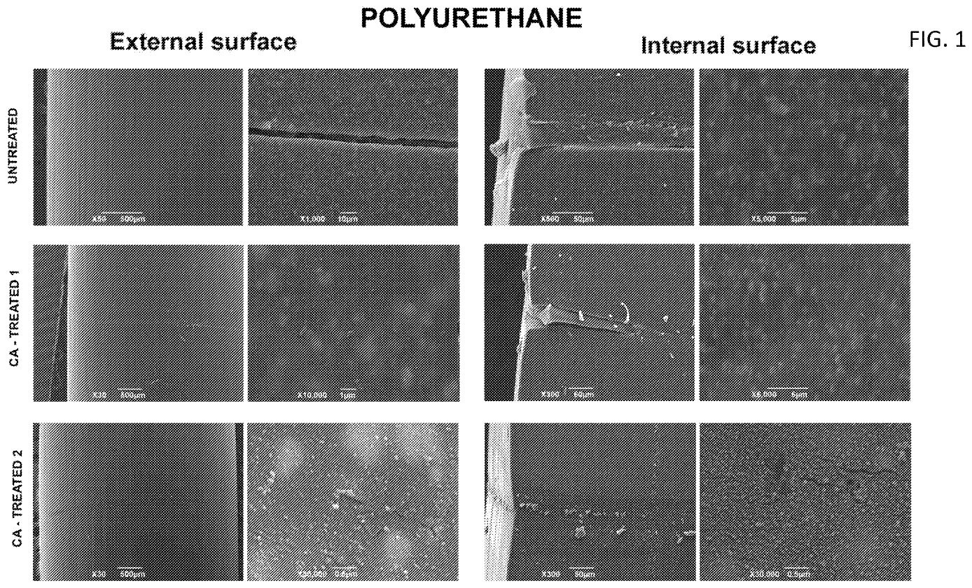

FIG. 1 highlights how the samples treated with solutions based on caffeic acid (CA) do not differ macroscopically from untreated samples (NT) when compared to each other at low magnification (50×). By increasing the magnification, it is possible to appreciate a uniform coverage which, based on specific variations of the caffeic acid-based solution (CA-1 and CA-2), can be modulated in thickness and texture.

### Polyamide Samples

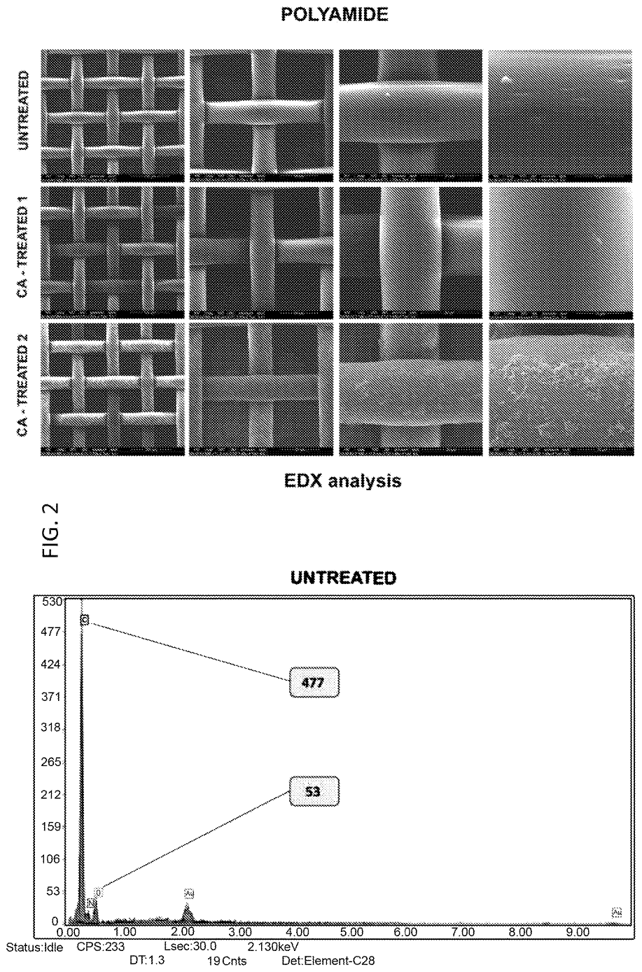

FIG. 2 highlights how the samples treated with solutions based on caffeic acid (CA-TREATED 1) do not differ macroscopically from untreated samples (NT) when compared to each other at low magnification (400×). The presence of the polyphenol-based coating was confirmed by the EDX analysis which highlighted an increase in the presence of C and O atoms compared to the NT samples. Energy-dispersive X-ray spectroscopy (also abbreviated EDX) is an analytical technique that enables the chemical characterization/elemental analysis of materials. A sample excited by an energy source (such as the electron beam of an electron microscope) dissipates some of the absorbed energy by ejecting a core-shell electron. A higher energy outer-shell electron then proceeds to fill its place, releasing the difference in energy as an X-ray that has a characteristic spectrum based on its atom of origin. This allows for the compositional analysis of a given sample volume that has been excited by the energy source. The position of the peaks in the spectrum identifies the element, whereas the intensity of the signal corresponds to the concentration of the element. By increasing the magnification, however, it is possible to appreciate a uniform coverage which, based on specific variations of the caffeic acid-based solution (CA-1 and CA-2), can be modulated in thickness and texture.

### Silicone Samples

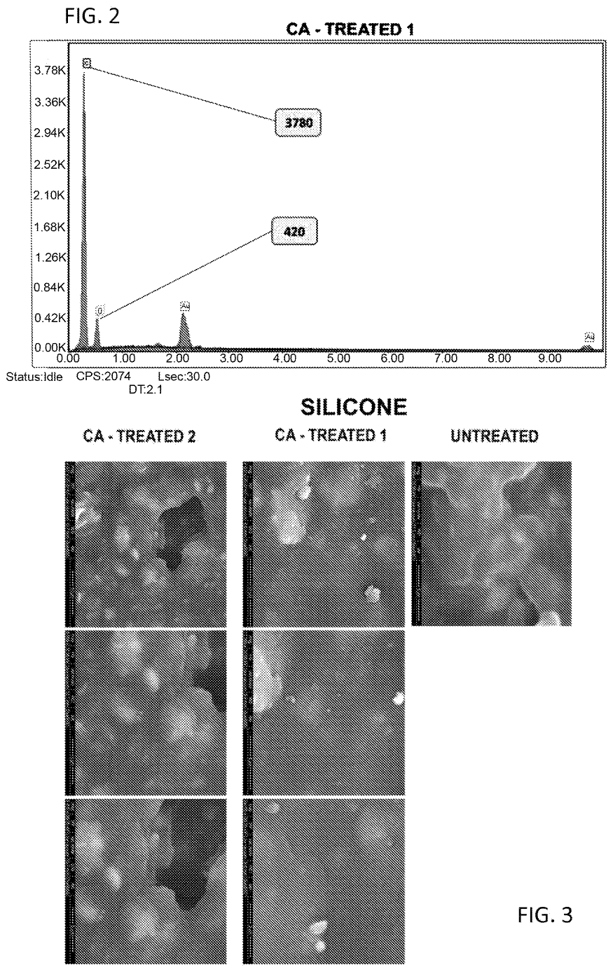

The silicone samples showed a different behavior compared to the other types of material analyzed. As evident in FIG. 3, the treatment with a caffeic acid-based solution guarantees the formation of a coating which, however, is visible only at high magnifications (starting from 6000×). The coating is visible as a result of the formation of cracks due to the prolonged permanence of the electron beam of the SEM. This feature makes the coating very interesting as it is not macroscopically detectable.

### Nuclear Magnetic Resonance (NMR) Evaluation

### Polyurethane Samples

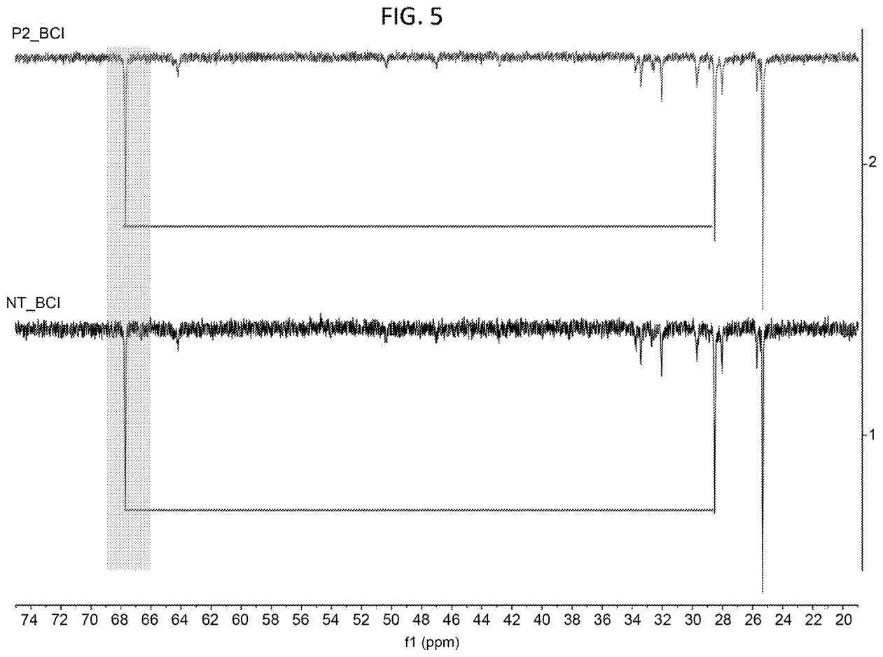

The H-NMR investigations do not show substantial differences in the peaks of the various treatments with solutions based on caffeic acid in the polyurethane samples. The P1 and P2 spectra are substantially identical (FIG. 4) showing no release of caffeic acid and confirming the stability of the treatment. In particular, the P2 treatment showed in C-NMR a decrease of the peak to about 68 ppm corresponding to the formation of a covalent bond with the terminal hydroxyl groups of the polyurethane chain (FIG. 5).

### Polyamide Samples

The H-NMR investigations (FIG. 6) confirm the stability of the interaction between the polyphenol solution based on caffeic acid and the polyamide samples. Furthermore, the disappearance of the peak at 3.7 ppm observable in the control (CTRL) sample is indicative of the formation of a covalent chemical bond between the terminal amino groups of the polyamide and the caffeic acid solution used for the coating (the signal highlighted in yellow corresponds to the signals of the protons in position 1 of the chain).

### Silicone Samples

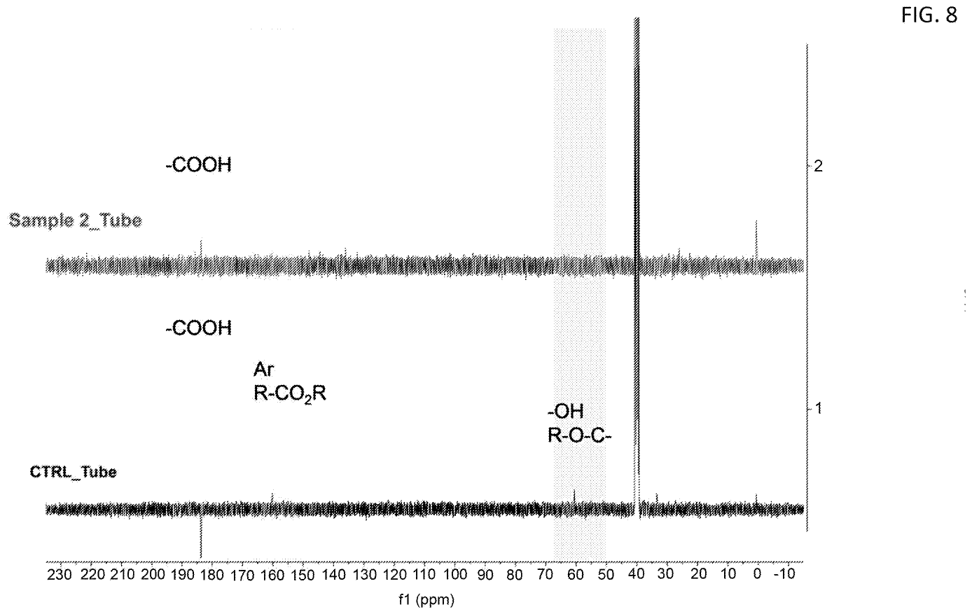

The H-NMR investigations confirm the stability of the interaction between the polyphenol solution based on caffeic acid and the silicone samples. In particular, H-NMR evidenced a significative H-mediated interaction confirmed by the presence of several peaks in the region comprised between 1.4 and 0.6 ppm (FIG. 7). Furthermore, the disappearance of the peak at 60 and 185 ppm observable in the control (CTRL) sample (FIG. 8) is indicative of the formation of a covalent chemical bond between polyphenols and silicon surfaces.

### Inhibition of Surface Adhesiveness to Serum Proteins

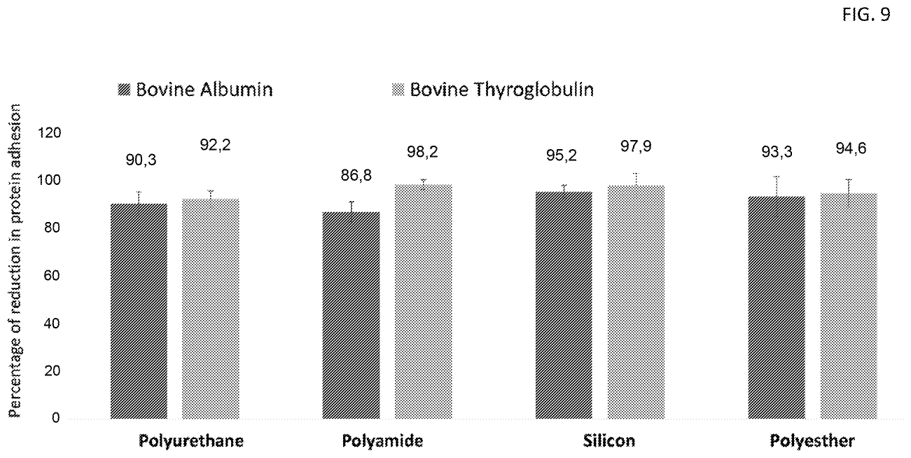

Samples of different plastic substrates treated and untreated with a polyphenolic solution based on caffeic acid according to the invention, were incubated for 24 hours at 37° C. in phosphate buffer containing 50 μg/ml of bovine serum albumin (66 kDa) or bovine thyroglobulin (330 kDa), with moderate but constant stirring. Subsequently, all samples were subjected to 3 washes in phosphate buffer for 3 minutes each to remove any protein residues not firmly bound to the surface. The protein adhered to the surface was measured and, considering the quantity of protein quantified on the untreated samples as a value of 100, the percentage of reduction in the variously treated samples was derived. As reported in FIG. 9, the treatment with the caffeic acid-based solution of the invention can ensure a reduction of protein adhesion greater than 90% generally.

Resistance to Tissue Bacterial Adhesion The anti-adhesive bacterial activity was evaluated regarding the Staphylococcus aureus(S. aureus), Escherichia coli(E. coli), and Proteus mirabilis(P. mirabilis). The bacteria were grown overnight in Tryptic Soy Broth (TSB) at 37° C. The total bacterial load was assessed by 10-factor serial dilutions in TSB (10⁻¹ to 10⁻⁷), sown in Petri dishes with appropriate selective medium, and kept in an overnight incubator. Following incubation, the CFU was counted to determine the effective concentration of the microorganism. Furthermore, the optical density at 600 nm was determined from each tiled dilution, to verify the linearity between the latter and the effective microbial load of the broth.

Samples of polyurethane (PU), polyamide (PA), silicone (SI), and polyester (PE), before (NT), and after treatment with a solution based on caffeic acid (CA, n=5 for each type of treatment) were prepared using a biopsy punch (3 mm in diameter), to obtain the same effective surface for bacterial adhesion. To eliminate any bacterial load before the adhesiveness test, samples were washed with PBS and incubated overnight at RT in PBS, supplemented with gentamicin (300 ug/mL) under moderate but constant agitation. Following overnight incubation, the samples were washed extensively in PBS to remove any remaining antibiotics that could skew the test results. Subsequently, the treated and untreated samples were exposed singularly to S. aureus, E. coli, and P. mirabilis bacterial suspensions (bacterial load 1×10⁷CFU/mL) for 90 min at RT under moderate but constant agitation.

Subsequently, the samples were subjected to three moderate vortexing passages to facilitate the detachment of the loosely bound bacteria and serial dilutions of the washing were plated in Petri dishes containing the appropriate selective growth media. Finally, after 24 hr of incubation at 37° C., the CFU was counted for each type of sample.

Considering the number of colonies found in the untreated samples as 100%, the percentage of adhesion inhibition was calculated for every single sample treated with the caffeic acid-based solution.

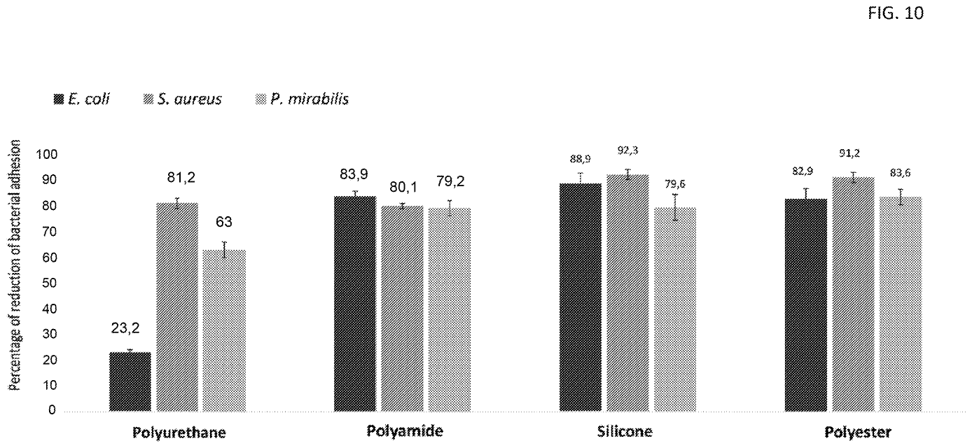

As shown in FIG. 10, the caffeic acid-based solution of the invention proved to be effective in inhibiting the surface adhesion of all the bacteria considered by at least 80%, regardless of the type of plastic support. The only exception is made up of polyurethane which already has excellent anti-adhesive activity against E. coli bacteria. In this specific case, the percentage of inhibition of bacterial adhesion was lower (23.2%) when compared to the other materials.

### Thrombin Generation Assay Test (TGA)

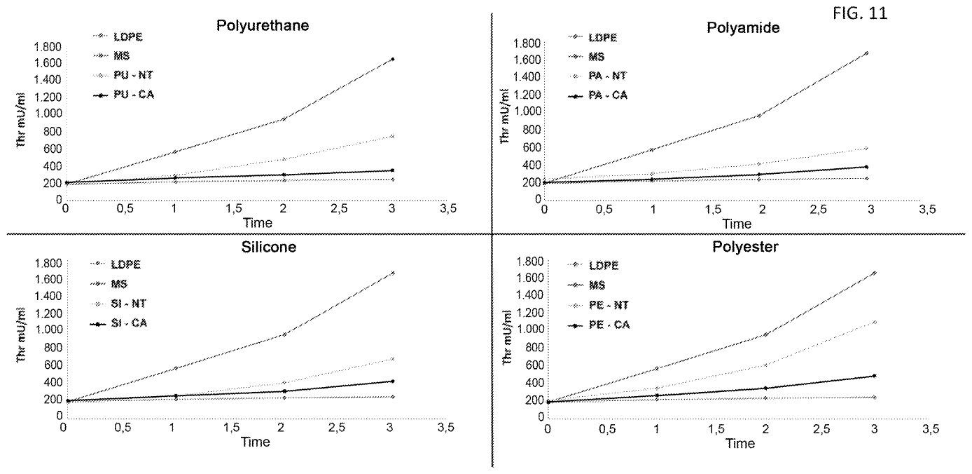

Samples of polyurethane (PU), polyamide (PA), silicone (SI), and polyester (PE), before (NT), and after treatment with a solution based on caffeic acid (CA, n=5 for each type of treatment), underwent a Thrombin Generation Assay Test (Haemoscan, Groningen, Netherlands). Thrombin is a key enzyme of the coagulation cascade. Its measurement gives direct information about the thrombogenicity of a biomaterial (i.e. its ability to form blood clots). In normal plasma, thrombin is captured into the fibrin meshwork and is rapidly inactivated by antithrombin III or other antiproteases. The short half-life of thrombin hampers its accurate enzymatic determination. The Thrombin Generation Assay is based on a special plasma product that enables the determination of thrombin activity in an incubation medium after this has been exposed to a biomaterial. This method is suited to evaluate the haemocompatibility of biomaterials and medical devices according to the international standard ISO 10993-4: 2002. Specimens were processed by following the instructions provided by the manufacturer. Briefly, samples were incubated in modified human plasma (plasma was provided by the manufacturer) with subsequent withdrawals at different time points. The thrombin concentration of the samples was determined from a calibration curve of optical density at 405 nm. The thrombin generation curve for each specimen was constructed by plotting the thrombin concentration versus the time points at which the samples were taken. The curve is used to determine the speed of thrombin generation, expressed as per cm² of a sample. Reference materials were provided by the manufacturer, in particular: low-density Polyethylene (LDPE, low propensity to thrombin generation) and Medical steel (MS, high propensity to thrombin generation). The results shown in FIG. 11 denote a general good resistance to thrombus formation by the original material (NT) except for polyester which tends to behave more similarly to medical steel. Surprisingly, the treatment with the caffeic acid-based solution (CA) can significantly reduce the thrombotic propensity in all the treated materials, inhibiting it up to about 60% (for polyurethane and polyester).

From the above disclosure, the advantages offered by the present invention will be immediately evident to the person skilled in the art.

For instance, the invention is capable of limiting the adhesion of protein and several bacteria strain on different plastic supports used for the manufacturing of medical devices, therefore preventing the formation of bacterial colonization and infections.

Also, the invention has been shown to protect the treated plastic support against the formation of blood clots and structured thrombi.

Such treatment showed a high chemical stability with the plastic substrates and it has proved effective in modifying the surface interaction properties of plastic polymers, allowing them to modulate the degree of hydrophilicity.

The present invention proved to be very stable and safe as confirmed by SEM and NMR analysis.

Last but not least, with the invention a method has been devised that can be carried out with conventional devices and machines.

The invention is susceptible to numerous modifications and variations, all of which are within the scope of the appended claims; moreover, all the elements may be substituted by other, technically equivalent elements.

### REFERENCES

1. EP3972659—Method for preventing the formation of calcified deposits and for inactivating xenoantigens in biologicals matrices;
2. EP3383446—Method for inactivating xenoantigens in biological tissues;
3. Eur J Cardiothorac Surg 2022; ezac583.doi: 10.1093/ejcts/ezac583. Online ahead of print.
4. Cardiol Cardiovasc Med 2022; 6(5):487-492.doi: 10.26502/fccm.92920287.
5. Tissue Eng Part A 2017; 23(19-20):1181-1195.doi: 10.1089/ten.tea.2016.0474.
6. ACS Appl Mater Interfaces 2016; 8(40):26570-26577. doi: 10.1021/acsami.6b08930.
7. Chem Commun (Camb) 2016; 52(2):312-315. doi: 10.1039/c5cc07090b.
8. Polymers (Basel) 2019; 11(7):1200. doi: 10.3390/polym 11071200.
9. Biomater Sci 2019; 7(12):5035-5043. doi: 10.103 9/c9bm01223k.

1. A method for imparting antimicrobial properties to a synthetic substrate, the method comprising contacting the synthetic substrate with a treatment solution based on caffeic acid.

2. The method substrate of claim 1, wherein the synthetic substrate is represented by a material selected from the group consisting of: polyurethane, polyesters, polyamides, polyethylene, silicones, polyether ether ketone (PEEK), polyacrylates, acrylic hydrogels, Teflon, polysiloxane, and fluorinated polymers.

3. The method of claim 1, wherein the method comprises a pre-treatment step of the synthetic substrate, wherein the synthetic substrate is incubated in a pre-treatment solution of a C1-C4 alcohol.

4. The method of claim 3, wherein the pre-treatment solution comprises methanol, ethanol, isopropanol or butanol.

5. The method of claim 3, wherein incubation is continued for a period of time of from 2 minutes to 24 hours.

6. The method of claim 3, wherein the pre-treatment solution has a concentration of about 10-100% (v/v) of the C1-C4 alcohol.

7. The method according to any one of the preceding claims of claim 3, wherein before the pre-treatment step the pre-treatment solution is maintained at a temperature of about −25° C. to −15°0 C. for a period of time from about 10 minutes to 5 hours.

8. The method of claim 1, wherein in the treatment solution the caffeic acid has a concentration of about 1-10 mg/ml.

9. The method of claim 1, wherein the treatment solution is a C1-C4 alcoholic solution.

10. The method of claim 1, wherein the treatment solution comprises methanol, ethanol, isopropanol or butanol.

11. The method of claim 1, wherein the treatment solution further comprises a second component.

12. The method of claim 11, wherein the second component has a concentration of about 0.1-20 mg/ml.

13. The method according to any one of the preceding claims of claim 11, wherein the second component is selected from the group consisting of: polyphenols and their salts or ester, phenolic compounds and their salts and derivatives, antibiotics or antimicrobial agents, methylated phenols, fatty acids and their esters, and metal-based solutions.

14. The method of claim 13, wherein the polyphenols are selected from the group consisting of: resveratrol, aloin, cyanarin, epigallocatechin, tannic acid, chlorogenic acid, hydroxytyrosol, rosmarinic acid, narigenin, gallic acid, hesperidin, quinic acid, eleonolic acid, pinoresinol, luteolin, apigenin, tangeritin, isorhamnetin, kaempferol, myricetin, eriodictyol, theaflavin, thearubigins, daidzein, genistein, glycitein, pterostilbene, delphinidin, malvidin, pelargonidin, peonidin, chicoric acid, ferulic acid, salicylic acid, baicalein, 5,7-dihydroxy-4-phenyl coumarin, rutin hydrate, 5,8-dihydroxy-1,4-naphthoquinone, 2,3-dichloro-5,8-dihydroxy-1,4-naphthoquinone, ethyl-3,4-dihydroxy-cinnamate, butyl gallate, 4-hydroxyl-4-biphenyl-carboxylic acid, oleuropein, garlic acid, magnolol, curcumin, and ethyl-3,5-dihydroxy-benzoate.

15. The method according to of claim 13, wherein the phenolic compounds are selected from the group consisting of: vanillin, cinnamic acids, phenylalanine, coumarins, xanthones, catechins, flavononids, flavones, chalcones, flavanonols, flavanols, leucoanthocyanidin, anthocyanidin, hydroxycinnamic acids, phenylpropanoids, and their salts or esters.

16. The method of claim 13, wherein the antibiotics or antimicrobial agents are selected from the group consisting of: penicillins, aminoglycosides, carbapenems, glycopeptides, and lipoglycopeptides such as vancomycin, monobactams aztreonam, oxazolidinones such as linezolid and tedizolid, rifamycins, streptogramins such as quinupristin and dalfopristin, cephalosporins, tetracyclines, macrolides, fluoroquinolones, and sulfonamides.

17. The method of claim 13, wherein the methylated phenols are selected from the group consisting of: +-tocopherol, β-tocopherol, γ-tocopherol, δ-tocopherol and tocotrienols.

18. The method to of claim 13, wherein the metal-based solutions are selected from the group comprising consisting of: acetates, sulphates, phosphates, chlorides, nitrites, nitrates or carbonates of any one from the group consisting of: iron, silver, gold, zinc, copper, barium, magnesium, and aluminum.

19. The method of claim 1, wherein the treatment solution is adjusted to a pH of about 2.5-9.0.

20. The method of claim 1, wherein the method comprises performing at least one treatment cycle, comprising steps i) and ii) wherein
i) the synthetic substrate is incubated in said the treatment solution and then
ii) the synthetic substrate is washed.

21. The method of claim 20, wherein step i) comprises at least one treatment cycle performed at pH 5.5.

22. The method of claim 21, wherein step i) further comprises at least one treatment cycle performed at pH 8.0.

23. The method according to any one of the preceding claims of claim 20, wherein step i) comprises from 1 to 5 treatment cycles performed at pH 5.5.

24. The method of claim 20, wherein step i) comprises from 1 to 5 treatment cycles performed at pH 8.0.

25. The method of claim 20, wherein step i) is performed in the dark.

26. The method of claim 20, wherein step i) is performed for a period of time of from about 5 to 25 minutes.

27. The method claims of claim 20, wherein washing is performed with a buffer solution.

28. The method of claim 20, wherein step ii) is performed for a period of time of from about 2 to 120 minutes.

29. The method of claim 20, wherein washing is performed with a washing solution selected from the group comprising consisting of: PBS (phosphate buffer), bicarbonate buffer, Dulbecco's Phosphate Buffered Saline, TBE (tris/borate/EDTA buffer), TE (Tris/EDTA) buffer, Tris-buffered saline (TBS), SSC (sodium chloride/sodium citrate), and SSPE (sodium chloride/sodium phosphate/EDTA)

30. The method of claim 20, wherein the method of further comprises a drying step.

31. The method of claim 30, wherein the drying step is performed at a temperature of about 30-45°C.

32. The method of claim 30, wherein the drying step is performed for a period of time of about 1 minute to 5 hours.

33. The method of claim 1, wherein the method provides to the synthetic substrate one or more properties selected from the group consisting of: inhibition of surface adhesiveness to serum proteins, resistance to tissue bacterial adhesion, and thrombin generation inhibition.

34. The method of claim 1, wherein said the antimicrobial properties are against Staphylococcus aureus, Pseudomonas aeruginosa, Escherichia coli, Proteus mirabilis, Enterococcus faecalis, Listeria monocytogenes, Salmonella enterica typhimurium, Streptococcus viridans, Mycobacterium chelonae, Candida, and Aspergillus brasiliensis.

35. A synthetic substrate obtained with the method one of claim 1.

36. A medical device comprising the synthetic substrate of claim 35.

37. The medical device of claim 36, wherein the medical device is selected from the group comprising consisting of: catheters, such as optionally the catheters being vascular catheters or urinary catheters, embolic protection filters, mesh for abdominal wall repair, syringes, kits for various types of use, laboratory tubes, blood bags, tools, gloves, trays, thermometers, and sutures.
